(19) United States
(12) Patent Application Publication
(10) Pub. No.: US 2025/0388510 A1
(43) Pub. Date: Dec. 25, 2025

(54) METHOD FOR MANUFACTURING PATTERN GLASS AND ELECTRONIC APPARATUS INCLUDING THE PATTERN GLASS

(71) Applicant: Samsung Display Co., Ltd., Yongin-si (KR)

(72) Inventors: Gwang Taek LEE, Yongin-si (KR); Tae Woo PARK, Yongin-si (KR)

(21) Appl. No.: 19/083,166

(22) Filed: Mar. 18, 2025

(30) Foreign Application Priority Data
Jun. 19, 2024 (KR) 10-2024-0079320
Sep. 6, 2024 (KR) 10-2024-0121678

(51) Int. Cl. C03C 17/32; C03C 17/00

(52) U.S. Cl. CPC C03C 17/32; C03C 17/002; C03C 2217/70; C03C 2218/11; C03C 2218/32; C03C 2218/34

(57) ABSTRACT

A method for manufacturing a pattern glass includes: providing a plurality of guide films on a pattern glass including flat areas and a pattern area between the flat areas, wherein the guide films are in contact with side surfaces of the flat areas; providing a first support film on top surfaces of the pattern glass and the guide films; providing a second support film on bottom surfaces of the pattern glass and the guide films; providing a shielding film having a through-hole formed therein on at least one selected from among the first and second support films, wherein the through-hole overlaps with the pattern area; injecting an uncured resin into the pattern area of the pattern glass through an injection channel formed between the guide films; and curing the uncured resin filled in the pattern area by irradiating a laser beam toward the pattern area exposed through the through-hole.

### CROSS-REFERENCE TO RELATED APPLICATION

The present application claims priority to and the benefit of Korean Patent Application No. 10-2024-0079320, filed on Jun. 19, 2024, and Korean Patent Application No. 10-2024-0121678, filed on Sep. 6, 2024, in the Korean Intellectual Property Office, the entire content of which is hereby incorporated by reference.

### BACKGROUND

### 1. Field

Embodiments of the present disclosure generally relate to a method for manufacturing a pattern glass and an electronic apparatus including the pattern glass.

### 2. Description of the Related Art

With the development of multimedia, the importance of display devices has increased. Accordingly, various types (or kinds) of display devices such as an Organic Light Emitting Display (OLED) and a Liquid Crystal Display (LCD) have been used.

Recently, as display technologies are developed, research and development on display devices having flexible displays have been actively conducted. Because a flexible display can extend and/or reduce a display screen size by, for example, folding, bending, and/or sliding of the display screen, the flexible display is considerably contributing to a volume decrease and/or design change of display devices.

A pattern glass is a main component of a display device including a flexible display. In order to implement an operation of folding and/or bending a display screen, pattern grooves are formed in a partial area of the pattern glass, so that a set or predetermined mechanical degree of freedom is imparted to the pattern glass and display device.

The above information disclosed in this Related Art section is only for enhancement of understanding of the background of the disclosure and therefore it may contain information that does not form the prior art that is already known in this country to a person of ordinary skill in the art.

### SUMMARY

Aspects of some embodiments provide a method for manufacturing a pattern glass, in which a process of filling and curing resin in a pattern area of the pattern glass can be improved, and the manufacturing reliability of the pattern glass can be increased.

According to some embodiments of the present disclosure, a method for manufacturing a pattern glass includes: providing a plurality of guide films on a pattern glass including flat areas and a pattern area between the flat areas, wherein the plurality of guide films are in contact with side surfaces of the flat areas; providing a first support film on top surfaces of the pattern glass and the plurality of guide films; providing a second support film on bottom surfaces of the pattern glass and the plurality of guide films; providing a shielding film having a through-hole formed therein on at least one selected from among the first and second support films, wherein the through-hole overlaps with the pattern area; injecting an uncured resin into the pattern area of the pattern glass through an injection channel between the plurality of guide films; and curing the uncured resin filled in the pattern area by irradiating a laser beam toward the pattern area exposed through the through-hole.

According to some embodiments, the plurality of guide films may include first to fourth guide films. One of the flat areas may be between the first guide film and the second guide film. Another of the flat areas may be between the third guide film and the fourth guide film.

According to some embodiments, the injection channel may be provided between the first and third guide films and between the second and fourth guide films.

According to some embodiments, the method may further include providing a first adhesive film on the flat areas of the pattern glass and the top surfaces of the plurality of guide films between the providing of the plurality of guide films and the providing of the first support film.

According to some embodiments, the providing of the first support film may include attaching the first support film on a top surface of the first adhesive film.

According to some embodiments, the method may further include providing a second adhesive film on the flat areas of the pattern glass and the bottom surfaces of the plurality of guide films between the providing of the plurality of guide films and the providing of the second support film.

According to some embodiments, the providing of the second support film may include attaching the second support film on a bottom surface of the second adhesive film.

According to some embodiments, the providing of the shielding film may include the shielding film and the at least one selected from among the first and second support films such that the shielding film and the injection channel overlap with each other.

According to some embodiments, the injection channel may be defined by some of the plurality of guide films and the first and second support films.

According to some embodiments, the injecting of the uncured resin may include filling the uncured resin in a plurality of first groove patterns and a plurality of second groove patterns, which are formed in the pattern area, by a capillarity effect. The plurality of first groove patterns may have a shape recessed in a direction toward the bottom surface from the top surface of the pattern glass, and the plurality of second groove patterns may have a shape recessed in a direction toward the top surface from the bottom surface of the pattern glass.

According to some embodiments, the plurality of first groove patterns and the plurality second groove patterns may extend in a direction parallel to a direction in which the injection channel extends.

According to some embodiments, the plurality of first groove patterns and the plurality second groove patterns may be alternately provided along a direction intersecting a direction in which the injection channel extends.

According to some embodiments, the irradiating of the laser beam may include: curing the uncured resin filled in the plurality of first groove patterns into a plurality of first resin patterns; and curing the uncured resin filled in the plurality of second groove patterns into a plurality of second resin patterns.

According to some embodiments, any one of the plurality of first groove patterns and any one of the plurality of first resin patterns, which are adjacent to each other, may have shapes that are complementary to each other. Any one of the plurality of second groove patterns and any one of the plurality of second resin patterns, which are adjacent to each other, may have shapes that are complementary to each other.

According to some embodiments, top surfaces of the plurality of first resin patterns may be on the same plane as the top surface of the pattern glass, and bottom surfaces of the plurality of second resin patterns may be on the same plane as the bottom surface of the pattern glass.

According to some embodiments, the irradiating of the laser beam may include controlling an output of a light source that emits the laser beam.

According to some embodiments, the irradiating of the laser beam may include shielding the laser beam irradiated onto the shielding film. The uncured resin flowing in the injection channel may not be cured.

According to some embodiments, the first and second support films may include the same material as the pattern glass or a hydrophobic material.

According to some embodiments, the uncured resin may include a material having the same refractive index as the pattern glass.

According some embodiments, an electronic apparatus includes a pattern glass formed by: providing a plurality of guide films on a pattern glass including flat areas and a pattern area between the flat areas, wherein the plurality of guide films are in contact with side surfaces of the flat areas; providing a first support film on top surfaces of the pattern glass and the plurality of guide films; providing a second support film on bottom surfaces of the pattern glass and the plurality of guide films; providing a shielding film having a through-hole formed therein on at least one selected from among the first and second support films, wherein the through-hole overlaps with the pattern area; injecting an uncured resin into the pattern area of the pattern glass through an injection channel between the plurality of guide films; and curing the uncured resin filled in the pattern area by irradiating a laser beam toward the pattern area exposed through the through-hole.

### BRIEF DESCRIPTION OF THE DRAWINGS

The above and other features of embodiments of the present disclosure will become more apparent by describing in further detail embodiments thereof with reference to the accompanying drawings; however, the subject matter of the present disclosure may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that if (e.g., when) an element is referred to as being “between” two elements, it can be the only element between the two elements, or one or more intervening elements may also be present. Like reference numerals refer to like elements throughout.

FIG. 1 is a perspective view illustrating aspects of embodiments of a display device including a pattern glass.

FIG. 2 is a perspective view illustrating a state in which the display device shown in FIG. 1 is folded.

FIG. 3 is a schematic exploded perspective view of the display device shown in FIG. 1.

FIG. 4 is a conceptual view schematically illustrating a structure of the display device shown in FIG. 1.

FIG. 5 is a flowchart illustrating aspects of embodiments of a method for manufacturing a pattern glass member.

FIG. 6 is a perspective view illustrating a step of preparing a pattern glass.

FIG. 7 is a perspective view illustrating a step of providing a plurality of guide films on side surfaces of the pattern glass.

FIG. 8 is a perspective view illustrating a step of providing first and second support films respectively on top surfaces and bottom surfaces of the pattern glass and the plurality of guide films.

FIG. 9 is a perspective view illustrating a step of providing a shielding film on the first support film.

FIG. 10 is a perspective view illustrating a state in which a structure having the shielding film provided on the first support film shown in FIG. 9 is viewed in a direction opposite to a third direction.

FIG. 11 is a sectional view illustrating aspects taken along line II-II′ shown in FIG. 10.

FIG. 12 is a cross-sectional view illustrating aspects taken along line III-III′ shown in FIG. 10.

FIG. 13 is a conceptual view illustrating a state in which uncured resin filled in each of the first to second groove patterns shown in FIG. 11 is exposed to a laser beam to be respectively cured as first and second resin patterns.

FIG. 14 is a conceptual view illustrating a state in which the shielding film shown in FIG. 12 shields the laser beam.

FIG. 15 is a side view illustrating a pattern glass manufactured according to the method shown in FIGS. 5-14.

FIG. 16 is a block diagram of an electronic apparatus according to an embodiment.

FIG. 17 shows schematic views of various embodiments of an electronic apparatus.

### DETAILED DESCRIPTION

Hereinafter, aspects of some embodiments of the present disclosure will be described in more detail with reference to the accompanying drawings. In the description below, only a part useful to understand an operation according to embodiments of the present disclosure is described and the descriptions of other parts are omitted in order not to unnecessarily obscure the subject matter of the present disclosure. In embodiments, the present disclosure is not necessarily limited to the example embodiments described herein, but may be embodied in various suitable different forms. Rather, the example embodiments described herein are provided to thoroughly and completely describe the disclosed contents and to sufficiently transfer the ideas of the disclosure to a person having ordinary skill in the art.

In the entire specification, if (e.g., when) an element is referred to as being “connected” or “coupled” to another element, it can be directly connected or coupled to the another element or be indirectly connected or coupled to the another element with one or more intervening elements interposed therebetween. The technical terms used herein are used only for the purpose of illustrating an example embodiment and not intended to limit the embodiment. It will be understood that if (e.g., when) a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” etc. may be used herein to describe various elements, these elements should not be necessarily limited by these terms. These terms are only used to distinguish one element from another element. Thus, a “first” element discussed below could also be termed a “second” element without departing from the spirit and scope of the present disclosure.

Spatially relative terms, such as “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the example term, “above,” may encompass both an orientation of above and below. The apparatus may be otherwise oriented (e.g., rotated 90 degrees or at other orientations) and the spatially relative descriptors used herein interpreted accordingly.

Embodiments of the disclosure are described here with reference to schematic diagrams of idealized embodiments (and an intermediate structure) of the present disclosure, so that changes in a shape as shown due to, for example, manufacturing technology and/or a tolerance may be expected. Therefore, embodiments of the present disclosure shall not be necessarily limited to the specific shapes of a region shown here, but include shape deviations caused by, for example, the manufacturing technology. The regions shown in the drawings are schematic in nature, and the shapes thereof do not represent the actual shapes of the regions of the device, and do not limit the scope of the disclosure.

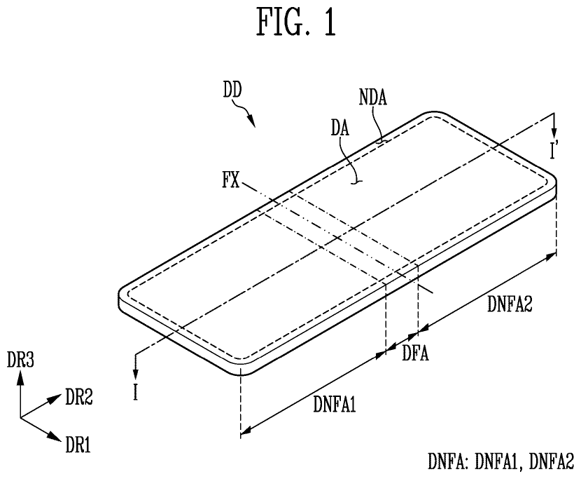

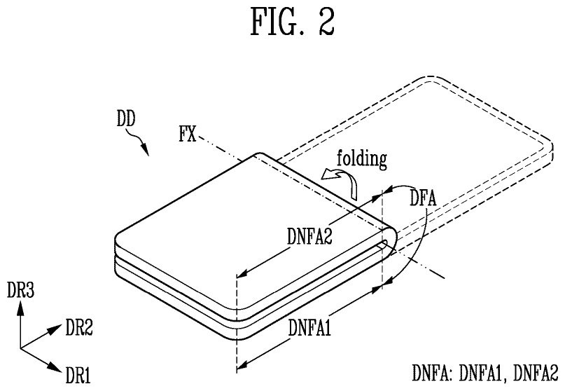

FIG. 1 is a perspective view illustrating aspects of embodiments of a display device including a pattern glass. FIG. 2 is a perspective view illustrating a state in which the display device shown in FIG. 1 is folded.

Referring to FIGS. 1-2, a display device DD in accordance with an embodiment of the present disclosure DD is a device which displays moving images and/or still images, and may be used as a display screen of not only portable electronic devices, such as mobile phones, smartphones, tablet personal computers (PCs), smart watches, watch phones, mobile communication terminals, electronic notepads, electronic books, portable multimedia players (PMPs), navigation systems, and ultra-mobile PCs (UMPCs), but also various other suitable products such as televisions, laptops, monitors, billboards, and Internet-of-Things (IoT) devices.

The display device DD may be a single foldable display device foldable and/or bendable with respect to a folding axis FX, but embodiments are not necessarily limited thereto. For example, the display device DD may be a multi-foldable display device foldable with respect to a plurality of folding axes.

FIG. 1 illustrates a first state of the display device DD, in which a display device folding area DFA is not bent, and FIG. 2 illustrates a second state of the display device DD, in which the display device folding area DFA is bent.

The display device DD may have a three-dimensional stereoscopic shape. In the drawings, a direction parallel to a first side (lateral side) of the display device DD is indicated as a first direction DR1, a direction parallel to a second side (longitudinal side) of the display device is indicated as a second direction DR2, and a thickness direction of the display device DD is indicated as a third direction DR3. Hereinafter, unless otherwise specified, a “specific direction” may mean both the corresponding direction and a direction opposite thereto. In embodiments, if (e.g., when) both directions extending to both sides need to be distinguished from each other, one side will be referred to as one side in the direction and the other side will be referred to as the other side in the direction. For example, a direction in which an arrow shown in FIG. 2 faces may mean one side, and a direction opposite thereto may mean the other side.

In embodiments, as shown in FIG. 1, a planar shape of the display device DD may have a quadrangular shape such as a rectangle having lateral sides shorter than longitudinal sides, and each of corners of the display device DD may have a right-angled or rounded shape. However, the present disclosure is not necessarily limited thereto.

The display device DD may include the display device folding area DFA and a display device non-folding area DNFA.

The display device folding area DFA is a foldable and/or bendable area, and may be between first and second display device non-folding areas DNFA1 and DNFA2 which will be further described herein. In the drawings, it is described that the display device folding area DFA extends in a direction crossing the display device DD in the first direction DR1. However, embodiments are not necessarily limited thereto. For example, the display device folding area DFA may extend in a direction crossing the second direction DR1. Also, the display device folding area DFA may be formed at a center of the display device DD with respect to the second direction DR2, but the present disclosure is not necessarily limited thereto. For example, the display device folding area DFA may be formed at a position deviant from the center of the display device DD.

The display device non-folding area DNFA may be a flat area of the display device DD, which is not folded or bent, and include the first display device non-folding area DNFA1 and the second display device non-folding area DNFA2. In embodiments, the display device non-folding area DNFA may correspond to the other area except the display device folding area DFA.

In the drawings, it is described that the first display device non-folding area DNFA1 and the second display device non-folding area DNFA2 have shapes symmetrical to each other in the second direction DR2 with respect to the display device folding area DFA. However, embodiments are not necessarily limited thereto. For example, the first display device non-folding area DNFA1 and the second display device non-folding area DNFA2 may have shapes asymmetrical to each other with respect to the display device folding area DFA.

The display device folding area DFA may be folded and/or bent with respect to the folding axis FX. In embodiments, the folding axis FX may be defined as a virtual axis extending in a direction parallel to the first direction DR1 in the display device folding area DFA, but the present disclosure is not necessarily limited thereto. For example, the folding axis FX may be defined as a virtual axis extending in a direction parallel to the second direction DR2 if (e.g., when) the display device folding area DFA extends in the second direction DR2. In embodiments, the folding axis FX may be defined as a virtual axis parallel to a direction in which the display device folding area DFA extends.

If (e.g., when) the display device folding area DFA is not folded, the display device DD may maintain the first state in which the display device folding area DFA is unfolded as shown in FIG. 1. In embodiments, if (e.g., when) the display device folding area DFA is folded, the display device DD may maintain the second state in which the display device folding area DFA is folded as shown in FIG. 2. The state of the display device DD may be changed from the first state to the second state as the display device folding area DFA is folded and/or bent. According to such an operation, a length of the display device DD in the second direction DR2 can be decreased, and thus a user can conveniently carry the display device DD.

The display device DD may include a display area DA and a non-display area NDA.

The display area DA may be a partial area of the display device DD, in which a plurality of pixels provide a screen. The non-display area NDA may be another area of the display device DD, in which the plurality of pixels are not provided such that the screen is not provided. The non-display area NDA may correspond to, for example, a bezel.

In embodiments, each of the display device folding area DFA and the first and second display device non-folding areas DNFA1 and DNFA2 may include at least a portion of the display area DA. A shape of the display area DA on a plane may follow a planar shape of the display device DD in the first state. For example, the planar shape of the display device DD in the first state may be a rectangular shape, the planar shape of the display area DA may also be a rectangular shape.

The non-display area NDA may be provided at the periphery of the display area DA. In embodiments, each of the display device folding area DFA and the first and second display device non-folding areas DNFA1 and DNFA2 may include at least a portion of the non-display area NDA. In the drawings, it is illustrated that the non-display area NDA is provided to completely surround the display area DA. However, the present disclosure is not necessarily limited thereto. For example, the non-display area NDA may partially surround the display area DA.

In embodiments, the display device DD may be folded in an in-folding manner in which the display device DD is folded in the second state such that a top surface of the first display device non-folding area DNFA1 and a top surface of the second display device non-folding area DNFA2 face each other as shown in FIG. 2. However, the present disclosure is not necessarily limited thereto. For example, the display device DD may be folded in an out-folding manner in which the display device DD is folded in the second state such that a bottom surface of the first display device non-folding area DNFA1 and a bottom surface of the second display device non-folding area DNFA2 face each other.

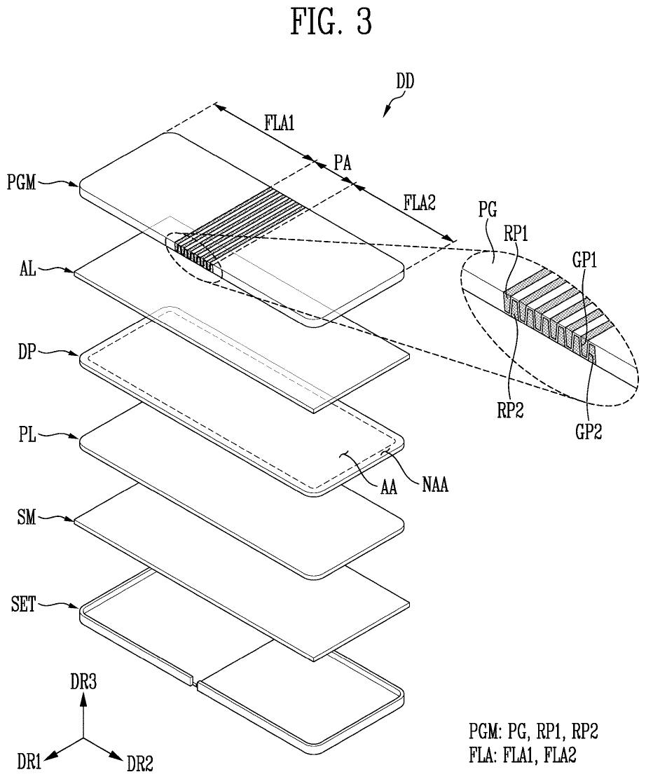

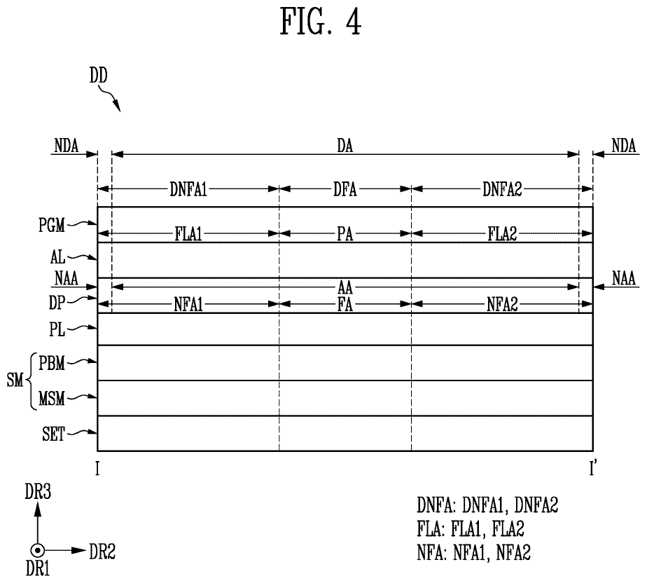

Hereinafter, a structure of the display device DD will be described in more detail with reference to FIGS. 3-4.

FIG. 3 is a schematic exploded perspective view of the display device shown in FIG. 1. FIG. 4 is a conceptual view schematically illustrating a structure of the display device shown in FIG. 1.

Referring to FIGS. 3-4, the display device DD may include a pattern glass member PGM, an adhesive layer AL, a display panel DP, a protective layer PL, a sub-module SM, and a set member SET.

The pattern glass member PGM may be on a top surface of the adhesive layer AL to protect the display panel DP from the outside. The pattern glass member PGM may include a pattern glass PG, a plurality of first resin patterns RP1, and a plurality of second resin patterns RP2.

The pattern glass PG may be made of a transparent material, and be made of, for example, glass and/or plastic. In embodiments, the pattern glass PG may be an ultra-thin glass having a thickness of 0.3 mm or less, or be configured to include a transparent polyimide film.

The pattern glass PG may include a pattern area PA and a flat area FLA.

The pattern area PA may overlap with the display device folding area DFA in the thickness direction of the display device DD, to be folded and/or bent together with the display device folding area DFA if (e.g., when) the display device folding area DFA is folded and/or bent. The pattern area PA may be between first and second flat areas FLA1 and FLA2 which will be further described herein. A plurality of first groove patterns GP1 and a plurality of second groove patterns GP2 may be formed in the pattern area PA.

The plurality of first groove patterns GP1 may have a shape in a direction toward a bottom surface from a top surface of the pattern glass PG. A plurality of first resin patterns PR1 may be provided in empty spaces in which the plurality of first groove patterns GP1 are formed recessed from the top surface of the pattern glass PG as described above. In embodiments, any one of the plurality of first groove patterns GP1 and any one of the plurality of first resin patterns PR1, which are adjacent to each other, may have shapes that are complementary to each other.

The plurality of second groove patterns GP2 may have a shape recessed in a direction toward the top surface from the bottom surface of the pattern glass PG. A plurality of second resin patterns RP2 may be provided in empty spaces in which the plurality of second groove patterns GP2 are formed recessed from the bottom surface of the pattern glass PG as described above. In embodiments, any one of the plurality of second groove patterns GP2 and any one of the second resin patterns RP2, which are adjacent to each other, may have shapes that are complementary to each other.

The plurality of first groove patterns GP1 and the plurality of second groove patterns GP2 may extend in a direction parallel to the direction (e.g., the first direction DR1) in which the folding axis FX described with reference to FIG. 1 extends. In embodiments, the plurality of first groove patterns GP1 and the plurality of second groove patterns GP2 may be alternately provided along a direction (e.g., the second direction) intersecting the direction in which the folding axis FX extends.

As the plurality of first and second groove patterns GP1 and GP2 are formed in the pattern area PA of the pattern glass PG as described above, bending characteristics of the pattern area PA of the pattern glass GP are increased, so that a bending operation of the pattern glass member PGM can be easily performed as the display device DD is folded and/or bent.

The flat area FLA may include the first flat area FLA1 and the second flat area FLA2.

The first flat area FLA1 is a partial area of the pattern glass PG, and may be provided at one side of the pattern area PA. The first flat area FLA1 may function to protect the first display device non-folding area DNFA1, which is ordinarily flat, while overlapping with the first display device non-folding area DNFA1 in the thickness direction of the display device DD.

Like the first flat area FLA1, the second flat area FLA2 is a partial area of the pattern glass PG, and may be provided at an opposite side of the pattern area PA, which is opposite to the first flat area FLA1 with respect to the pattern area PA. The second flat area FLA2 may protect the second display device non-folding area DNFA2 of the display device DD, which is ordinarily flat, while overlapping with the second display device non-folding area DNFA2 in the thickness direction of the display device DD.

The plurality of first resin patterns RP1 may be provided in the empty spaces in which the plurality of first groove patterns GP1 are formed recessed from the top surface of the pattern glass PG. Top surfaces of the plurality of first resin patterns RP1 may be on the same plane as the top surface of the pattern glass PG.

The plurality of second resin patterns RP2 may be provided in the empty spaces in which the plurality of second groove patterns GP2 are formed recessed from the bottom surface of the pattern glass PG. Bottom surfaces of the plurality of second resin patterns RP2 may be on the same plane as the bottom surface of the pattern glass PG.

The plurality of first and second resin patterns RP1 and RP2 may include a material having the same refractive index as the pattern glass PG, so that the plurality of first and second groove patterns GP1 and GP2 formed in the pattern area PA of the pattern glass PG can be prevented from being viewed by a user (or a visibility thereof may be reduced). In embodiments, the plurality of first and second resin patterns RP1 and RP2 may include a synthetic resin material. For example, the plurality of first and second resin patterns RP1 and RP2 may include at least one selected from among urethane resin, epoxy resin, polyester resin, polyether resin, acrylate resin, acrylonitrile-butadiene-styrene (ABA) resin, and rubber. In embodiments, the plurality of first and second resin patterns RP1 and RP2 may include at least one selected from among phenylene, polyethylene terephthalate (PET), polyimide (PI), polyamide (PAI), polyethylene naphthalate (PEN), and polycarbonate (PC).

The adhesive layer AL may be between the pattern glass member PGM and the display panel DP which will be further described herein. The pattern glass member PGM and the display panel DP may be attached to each other by the adhesive layer AL. The adhesive layer AL may include a pressure sensitive adhesive (PSA) and/or an optically clear adhesive (OCA), but the kind of adhesive is not necessarily limited thereto.

The display panel DP may be under the pattern glass member PGM, and be attached to the pattern glass member PGM by the adhesive layer AL between the display panel DP and the pattern glass member PGM.

The display panel DP is a panel that displays a screen, and any suitable kinds of display panels including an organic light emitting display panel including an organic light emitting layer, a micro light emitting diode (LED) display panel including a micro LED, a quantum dot light emitting display panel including a quantum dot light emitting diode, and/or an inorganic light emitting display panel including an inorganic light emitting element may be applied as the display panel in accordance with embodiments of the present disclosure.

The display panel DP may include a folding area FA and a non-folding area NFA.

The folding area FA may be folded and/or bent together with the display device folding area DFA and the pattern area PA if (e.g., when) the display device folding area DFA and the pattern area PA are folded and/or bent, while overlapping with the display device folding area DFA and the pattern area PA in the thickness direction of the display device DD. The folding area FA may be between first and second non-folding areas NFA1 and NFA2 which will be further described herein.

The non-folding area NFA may include the first non-folding area NFA1 and the second non-folding area NFA2.

The first non-folding area NFA1 is a partial area of the display panel DP, and may be provided at one side of the folding area FA. The first non-folding area NFA1 may function to protect the first display device non-folding area DNFA1 of the display device DD, which is ordinarily flat, while overlapping with the first display device non-folding area DNFA1 and the first flat area FLA1 in the thickness direction of the display device DD.

Like the first non-folding area NFA1, the second non-folding area NFA2 is a partial area of the display panel DP, and may be provided at an opposite side of the folding area FA, which is opposite to the first non-folding area NFA1 with respect to the folding area FA. The second non-folding area NFA2 may function to protect the second display device non-folding area DNFA2 of the display device DD, which is ordinarily flat, while overlapping with the second display device non-folding area DNFA2 and the second flat area FLA2 in the thickness direction of the display device DD.

The display area DP may include an active area AA that defines the display area DA of the display device DD and a non-active area NAA that surrounds the active area AA. Each of the folding area FA and the first and second non-folding areas NFA1 and NFA2 may include at least a portion of the active area AA and at least a portion of the non-active area NAA. In embodiments, the active area AA of the display panel DP may include a plurality of pixels that emits light, and the non-active area NAA of the display panel DP may be an area not including the pixels.

The protective layer PL may be under the display panel DP, support the display panel DP and protect a bottom surface of the display panel DP. The protective layer PL may be made of plastic and/or polymer such as polyethylene terephthalate (PET) and/or polyimide (PI). In FIGS. 3-4, it is illustrated that the protective layer PL overlaps with the display device folding area DFA of the display device DD. However, embodiments of the present disclosure are not necessarily limited thereto. For example, a portion of the protective layer PL, which overlaps with the display device folding area DFA, may be removed such that the display device DD is smoothly folded and/or bent.

The sub-module SM may be under the protective layer PL, and include a panel bottom member PBM and a metal support member MSM.

The panel bottom member PBM may function to absorb light and/or heat, which is introduced from the outside, and/or physical impact applied from the outside. In embodiments, the panel bottom member PBM may include at least one selected from among of a light shielding portion to absorb light incident from the outside, a buffering portion to absorb impact from the outside, and a heat dissipation portion to efficiently discharge heat of the display panel DP.

The light shielding portion may shield transmission of light, thereby preventing components under the panel bottom member PBM, e.g., a digitizer and/or the like, which will be further described herein, from being viewed at the front of the display panel DP (or reduced a visibility thereof). The light shielding portion may include a light absorbing material such as a black pigment and/or a black dye.

The buffering portion may absorb external impact, thereby preventing or reducing damage to the display panel DP. The buffering portion may be provided as a single layer or a multi-layer. For example, the buffering portion may be made of a polymer resin such as polyurethane, polycarbonate, polypropylene and/or polyethylene, and/or be made of a material having elasticity, such as a sponge formed by foaming and molding an acryl-based material.

The heat dissipation portion may include a first heat dissipation layer including graphite, carbon nano tubes, and/or the like and a second heat dissipation layer which has a function of shielding electromagnetic waves and is formed of a metal thin film such as copper, nickel, ferrite and/or silver, which has excellent thermal conductivity.

The metal support member MSM may function to support the bottom surface of the display panel DP. The metal support member MSM may be on a bottom surface of the panel bottom member PBM. The metal support member MSM may be made of a rigid material of which shape and/or volume is not easily changed by pressure from the outside. In embodiments, the metal support member MSM may be made of a metal, but the present disclosure is not necessarily limited thereto. For example, the metal support member MSM may be made of carbon fiber reinforced plastic (CFRP) including carbon fiber thread and resin surrounding the carbon fiber thread.

The metal support member MSM may include a mesh plate and a flat panel plate.

The mesh plate may be folded and/or bent together with the display device folding area DFA, the pattern PA, and the folding area FA if (e.g., when) the display device folding area DFA, the pattern PA, and the folding area FA are folded and/or bent, while overlapping with the display device folding area DFA, the pattern PA, and the folding area FA. The mesh plate may be between first and second flat panel plates which will be further described herein.

The flat panel plate may include a first flat panel plate and a second flat panel plate.

The first flat panel plate is a partial area of the metal support member MSM, and may be provided at one side of the mesh plate. The first flat panel plate may function to protect the first display device non-folding area DNFA1 such that the display device DD is not deformed by an external force in the first display device non-folding area DNFA1, while overlapping with the first display non-folding area DNFA1, the first flat area FLA1, and the first non-folding area NFA1 in the thickness direction of the display device DD.

Like the first flat panel plate, the second flat panel plate is a partial area of the metal support member MSM, and may be provided at an opposite side of the mesh plate, which is opposite to the first flat panel plate with respect to the mesh plate. The second flat panel plate may function to protect the second display device non-folding area DNFA2 such that the display device DD is not deformed by an external force in the second display device non-folding area DNFA2, while overlapping with the second display device non-folding area DNFA2, the second flat area FLA2, and the second non-folding area NFA2 in the thickness direction of the display device DD.

In embodiments, a digitizer which senses a magnetic field and/or an electromagnetic signal, emitted from an electronic pen and/or the like, thereby determining a touch coordinate, and/or the like may be further under the metal support member MSM.

The set member SET may function to accommodate other components of the display device DD therein. In embodiments, the set member SET may accommodate the pattern glass PG, the adhesive layer AL, the display panel DP, the protective layer PL and the sub-module SM. In embodiments, the set member SET may further include a hinge structure for easily facilitating folding and/or bending.

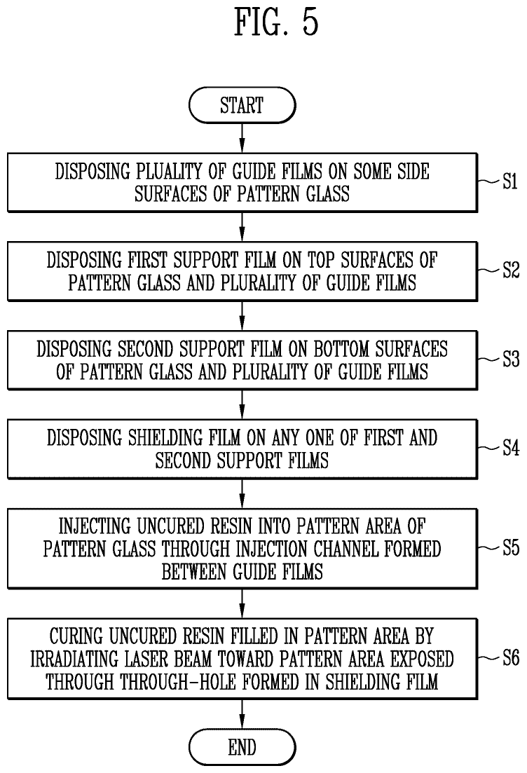

Hereinafter, embodiments of a method for manufacturing the pattern glass member PGM described above will be further described in more detail with reference to FIGS. 5-15.

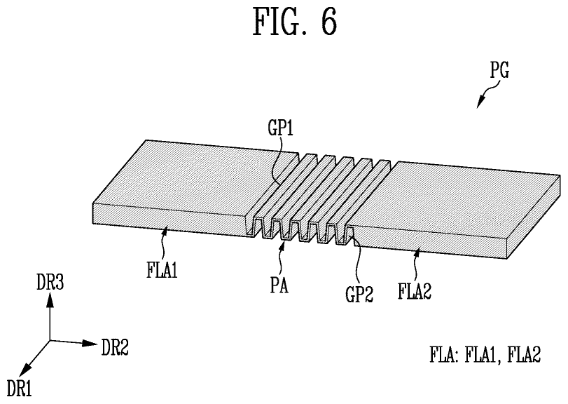

FIG. 5 is a flowchart illustrating aspects of a method for manufacturing a pattern glass member. FIGS. 6-15 are schematic perspective and cross-sectional views illustrating process steps of the method shown in FIG. 5.

Referring to FIG. 5, a method for manufacturing a pattern glass member PGM in accordance with an embodiment of the present disclosure may include step S1 of providing a plurality of guide film on some side surfaces of a pattern glass, step S2 of providing a first support film on top surfaces of the pattern glass and the plurality of guide films, step S3 of providing a second support film on bottom surfaces of the pattern glass and the plurality of guide films, step S4 of providing a shielding film on any one selected from among the first and second support films, step S5 of injecting an uncured resin into a pattern area of the pattern glass through an injection channel formed between the guide films, and step S6 of curing the uncured resin filled in the pattern area by irradiating a laser beam toward the pattern area exposed through a through-hole formed in the shielding film.

FIG. 6 is a perspective view illustrating a step of preparing a pattern glass.

Referring to FIGS. 5-6, a pattern glass PG is prepared, which includes flat areas FLA and a pattern area PA between the flat areas FLA. As described above, first and second groove patterns GP1 and GP2 may be formed in the pattern area PA, a first flat area FLA1 may extend to one side of the pattern area PA, and a second flat area FLA2 may extend to an opposite side of the pattern area PA.

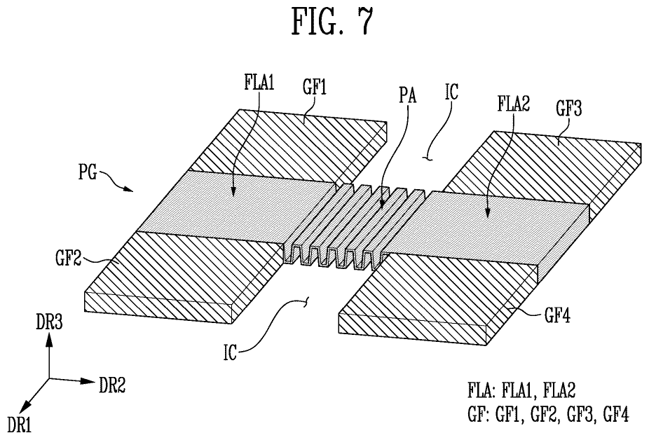

FIG. 7 is a perspective view illustrating a step of providing a plurality of guide films on side surfaces of the pattern glass.

Referring to FIGS. 5-7, a plurality of guide films GF are on side surfaces of the pattern glass PG (step S1). The plurality of guide films GF may be in contact with side surfaces of the flat areas FLA.

In some embodiments, a first guide film GF1 may be on one side surface of the first flat area FLA1, and a second guide film GF2 may be on an opposite side surface of the first flat area FLA1. Similarly to this, a third guide film GF3 may be on one side surface of the second flat area FLA2, and a fourth guide film GF4 may be on an opposite side surface of the second flat area FLA2. In embodiments, the first flat area FLA1 may be between the first guide film GF1 and the second guide film GF2, and the second flat area FLA2 may be between the third guide film GF3 and the fourth guide film GF4.

According to the above-described arrangement, an injection channel IC may be formed each of between the first guide film GF1 and the third guide film GF3 and between the second guide film GF2 and the fourth guide film GF4.

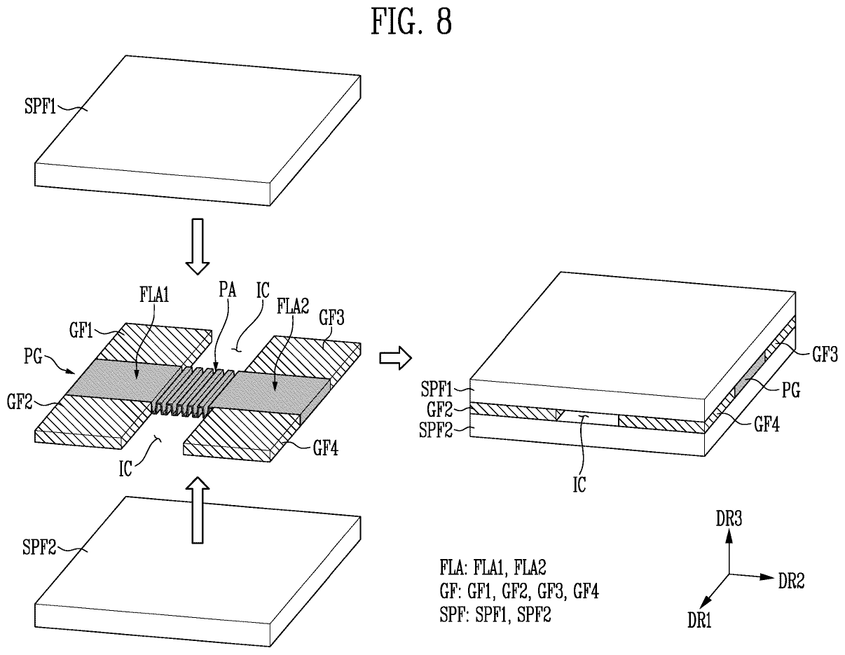

FIG. 8 is a perspective view illustrating a step of providing first and second support films respectively on top surfaces and bottom surfaces of the pattern glass and the plurality of guide films.

Referring to FIGS. 5-8, a first support film SPF1 is on top surfaces of the pattern glass PG and the plurality of guide films GF (step S2). In embodiments, a second support film SPF2 is on bottom surfaces of the pattern glass PG and the plurality of guide films GF (step S3). The first and second support films SPF1 and SPF2 may include the same material as the pattern glass PG or a hydrophobic material.

In embodiments, the steps S2 and S3 may be concurrently (e.g., simultaneously) performed, but the present disclosure is not necessarily limited thereto. For example, after the step S2 is performed, the step S3 may be performed. In embodiments, after the step S3 is performed, the step S2 may be performed.

According to the above-described arrangement, the injection channel IC may be defined by some of the plurality of guide films GF and the first and second support films SPF1 and SPF2. In embodiments, a top side of the injection channel IC formed between the first and third guide films GF1 and GF3 may be covered by the first support film SPF1, and a bottom side of the injection channel IC formed between the first and third guide films GF1 and GF3 may be covered by the second support film SPF2. Similarly to this, a top side of the injection channel IC formed between the second and fourth guide films GF2 and GF4 may be covered by the first support film SPF1, and a bottom side of the injection channel IC formed between the second and fourth guide films GF2 and GF4 may be covered by the second support film SPF2.

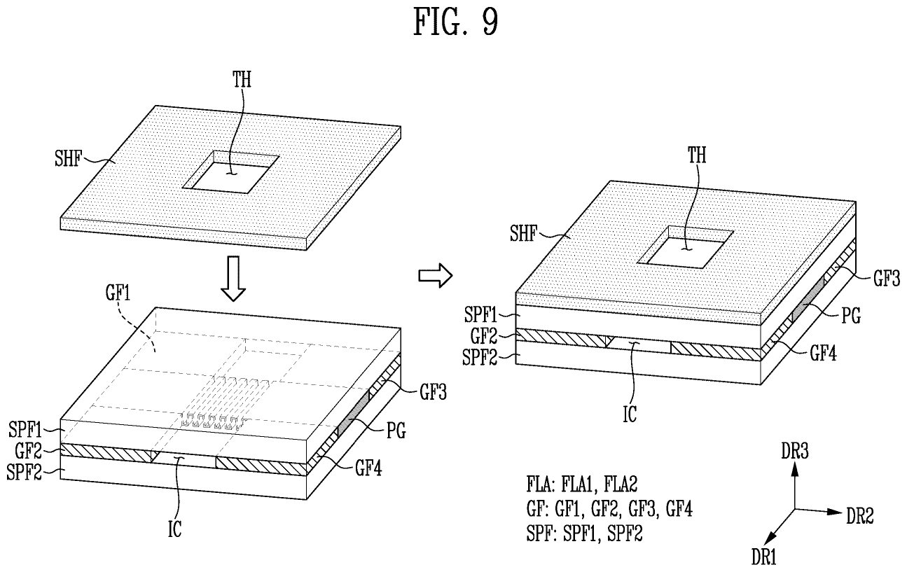

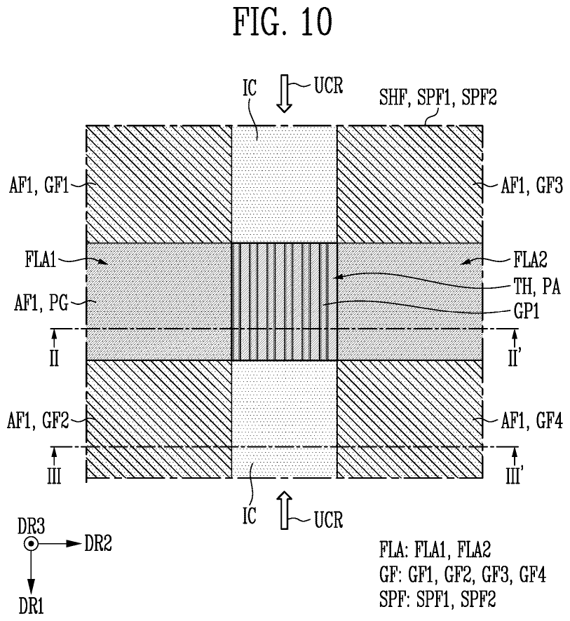

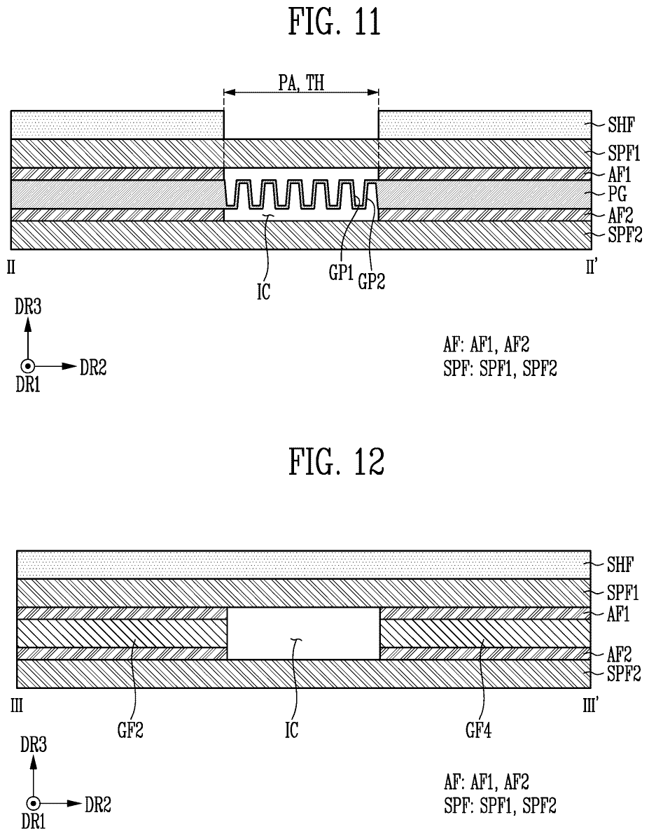

FIG. 9 is a perspective view illustrating a step of providing a shielding film on the first support film. FIG. 10 is a perspective view illustrating a state in which a structure having the shielding film provided on the first support film shown in FIG. 9 is viewed in a direction opposite to the third direction. FIG. 11 is a sectional view illustrating aspects taken along line II-II′ shown in FIG. 10. FIG. 12 is a sectional view illustrating aspects taken along line III-III′ shown in FIG. 10.

Referring to FIGS. 5 and 9 together, a shielding film SHF having a through-hole TH formed therein is provided on at least one selected from among the first and second support films SPF1 and SPF2 (step S4). For convenience of description, in FIGS. 9-10, it is illustrated that the shielding film SHF is on the first support film SPF1. However, the present disclosure is not necessarily limited thereto. In embodiments, the shielding film SHF may be under the second support film SPF2, and be concurrently (e.g., simultaneously) on the first support film SPF1 and under the second support film SPF2.

Referring to FIGS. 9-12, in embodiments, the through-hole TH of the shielding film SHF may overlap with the pattern area PA of the pattern glass PG. In embodiments, the shielding film SHF may have a frame shape covering the entire surface of the other areas of the first support film SPF1 except a partial area of the first support film SPF1, which overlaps with the pattern area PA. The step S4 of providing the shielding film SHF may further include a step of aligning the shielding film SHF and the first support film SPF1 such that the shielding film SHF and the injection channel IC overlap with each other.

Referring to FIGS. 10-12, a step of providing a first adhesive film AF1 on the flat areas FLA of the pattern glass GP and the top surfaces of the plurality of guide films GF may be further included between the step S1 of providing the plurality of guide films GF and the step S2 of providing the first support film SPF1. After the first adhesive film AF1 is provided on the plurality of flat areas FLA and the top surfaces of the plurality of guide films GF as described above, a step of attaching the first support film SPF1 on a top surface of the first adhesive film AF1 may be further included.

Similarly to this, a step of providing a second adhesive film AF2 on the flat areas FLA of the pattern glass GP and the bottom surfaces of the plurality of guide films GF may be further included between the step S1 of providing the plurality of guide films GF and the step S3 of providing the second support film SPF2. After the second adhesive film AF2 is provided on the plurality of flat areas FLA and the bottom surfaces of the plurality of guide films GF as described above, a step of attaching the second support film SPF2 on a bottom surface of the second adhesive film AF2 may be further included.

If (e.g., when) the steps S1 to S4 are all performed as described above, the pattern area PA of the pattern glass PG may be exposed to the outside through the injection channel IC.

In this state, referring back to FIG. 10, an uncured resin UCR is injected into the pattern area PA of the pattern glass PG through the injection channel IC (step S5).

Referring to FIGS. 11-12 together, the step S5 of injecting the uncured resin may include a step of filling the uncured resin UCR in the plurality of first groove pattern GP1 and the plurality of second groove patterns GP2, which are formed in the pattern area PA, by a capillarity effect. In embodiments, the uncured resin UCR injected through the injection channel IC may be filled in empty spaces in which the plurality of first groove patterns GP1 and the plurality of second groove patterns GP2 are formed.

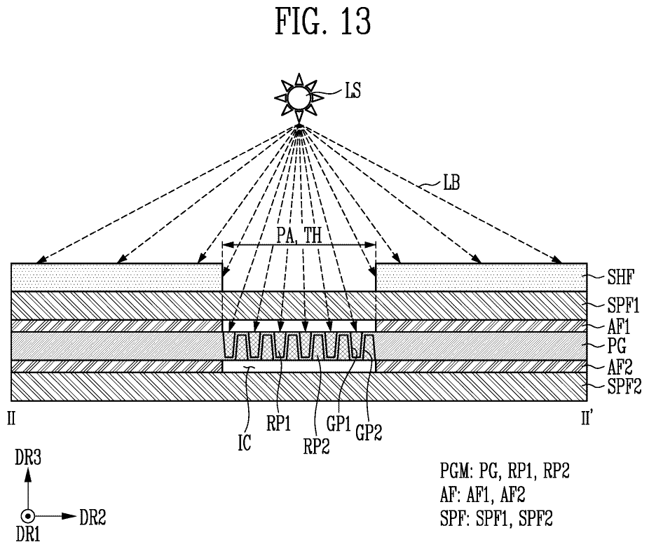

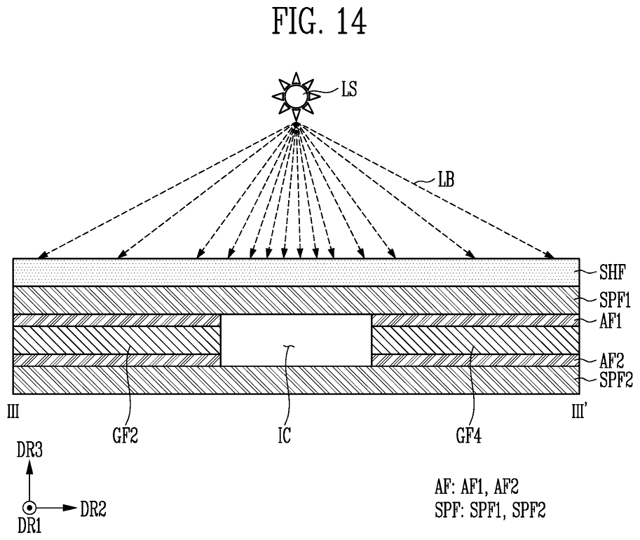

FIG. 13 is a conceptual view illustrating a state in which the uncured resin filled in each of the first to second groove patterns shown in FIG. 11 is exposed to a laser beam to be respectively cured as first and second resin patterns. FIG. 14 is a conceptual view illustrating a state in which the shielding film shown in FIG. 12 shields the laser beam.

Referring to FIGS. 5, and 13-14, the uncured resin UCR filled in the pattern area PA is cured by irradiating a laser beam LB toward the pattern area PA exposed through the through-hole TH formed in the shielding film SHF (step S6).

Referring to FIG. 13, in the step S6 of irradiating the laser beam LB, the laser beam LB may be irradiated in a direction toward the shielding film SHF from a light source LS. An output of the light source LS may be controlled in a pulse width modulation (PWM) or scanning manner, and the light source LS may emit the laser beam LB having a wavelength in a range of 100 nm to 400 nm. For example, the laser beam LB may be ultraviolet light. In embodiments, the output of the light source LS may be controlled, so that a curing speed of the uncured resin UCR filled in the first and second groove pattern GP1 and GP2 can be adjusted.

In embodiments, the step S6 of irradiating the laser beam LB may include a step of curing the uncured resin UCR filled in the plurality of first groove patterns GP1 into a plurality of first resin patterns RP1 and a step of curing the uncured resin UCR filled in the plurality of second groove patterns GP2 into a plurality of second resin patterns RP2.

As shown in FIGS. 13-14, while the uncured resin UCR filled in the first and second groove patterns GP1 and GP2 is cured into the plurality of first and second resin patterns RP1 and RP2 by irradiating the laser beam LB onto the pattern area PA of the pattern glass GS through the through-hole TH, the step S6 of irradiating the laser beam LB may include a step of shielding the laser beam LB irradiated onto the shielding film SHF. In embodiments, the laser beam LB irradiated onto the shielding film SHF may be absorbed in or reflected from the shielding film SHF. Therefore, the laser beam LB irradiated onto the shielding film SHF may not be transmitted toward the first support film SPF1 under the shielding film SHF.

In embodiments, because the injection channel IC is in a state in which the injection channel IC is covered by the shielding film SHF, the laser beam LB irradiated toward the injection channel IC may be absorbed or reflected by the shielding film SHF. Accordingly, the uncured resin UCR flowing in the injection channel IC is not cured but may continuously flow toward the pattern area PA to be filled in the first and second groove patterns GP1 and GP2.

If (e.g., when) the injection channel IC is not covered by the shielding film SHF but opened to the outside, the uncured resin UCR flowing in the injection channel IC may be cured together with the resin cured in the pattern glass PG by the laser beam LB. As shown in FIG. 10, the injection channel IC is a space distinguished from the pattern glass PG, and an additional process for removing the remainder except the resin formed in the pattern glass PG after a curing process is ended is utilized or required if (e.g., when) the uncured resin is cured in the injection channel IC.

According to the method in accordance with the above-described embodiments, the injection channel IC having the uncured resin injected therethrough is covered with the shielding film SHF, so that the uncured resin UCR flowing in the pattern area along the injection channel IC is not cured by the laser beam LB but can be continuously filled in the pattern area PA. Accordingly, the uncured resin UCR filled in the pattern area PA onto which the laser beam LB is irradiated through the through-hole TH can be intensively cured using the uncured resin UCR as a target. Further, because the uncured resin UCR flowing in the injection channel IC is not cured, the pattern glass member PGM can be manufactured without any additional process of removing the uncured resin UCR flowing in the injection channel IC.

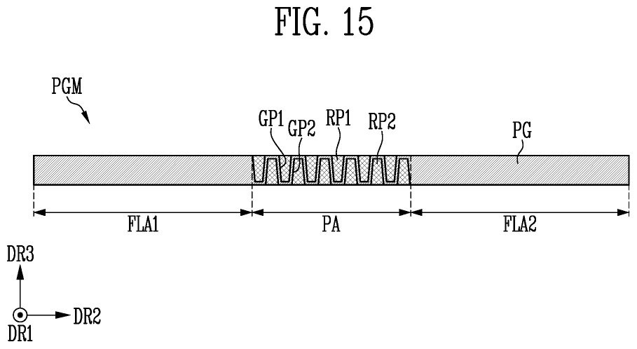

FIG. 15 is a side view illustrating a pattern glass manufactured according to the method shown in FIGS. 5-14.

Referring to FIG. 15, after the plurality of first and second resin patterns RP1 and RP2 are formed in the first and second groove patterns GP1 and GP2, respectively, the pattern glass member PGM may be completed by separating or removing the shielding film SHF, the first and second support films SPF1 and SPF2, the first and second adhesive films AF1 and AF2, and the first to fourth guide films GF1 to GF4.

In embodiments, the top surfaces of the plurality of first resin pattern RP1 may be on the same plane as the top surface of the pattern glass PG. In embodiments, the top surfaces of the plurality of second resin pattern RP2 may be on the same plane as the bottom surface of the pattern glass PG. This may be because the output of the light source LS may be controlled by considering a characteristic of the uncured resin UCR contracted in curing, and accordingly, the curing speed of the first and second resin patterns RP1 and RP2 can be controlled. As such, if (e.g., when) the curing speed of the first and second resin patterns RP1 and RP2 is controlled, the curing speed of the first and second resin patterns RP1 and RP2 is controlled such that the uncured resin UCR can be continuously injected through the injection channel IC until a set or specific time at which the top and bottom surfaces of the plurality of first and second groove patterns GP1 and GP2 are on the same planes as the top and bottom surfaces of the pattern glass PG, respectively. As a result, the manufacturing reliability of the pattern glass member PGM can be improved.

In the method for manufacturing the pattern glass in accordance with embodiments of the present disclosure, a process of filling and curing a resin in the pattern area of the pattern glass can be improved. For example, the injection channel of an uncured resin is covered with the shielding film, so that the uncured resin flowing in the pattern area along the injection channel is not cured by the laser beam but can be continuously filled in the pattern area.

Also, in the method for manufacturing the pattern glass in accordance with embodiments of the present disclosure, the manufacturing reliability of the pattern glass can be improved. For example, the output of the light source may be controlled, so that the top and bottom surfaces of the resin patterns cured and formed in the pattern area of the pattern glass can be on the same planes as the top and bottom surfaces of the pattern glass, respectively.

A display device according to an embodiment is applicable to various types of electronic devices. In an embodiment, an electronic device includes the above-described display device and may further include other modules or devices having additional functions in addition to the display device.

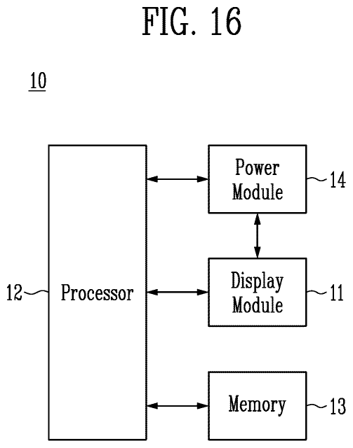

FIG. 16 is a block diagram of an electronic device according to an embodiment. Referring to FIG. 16, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

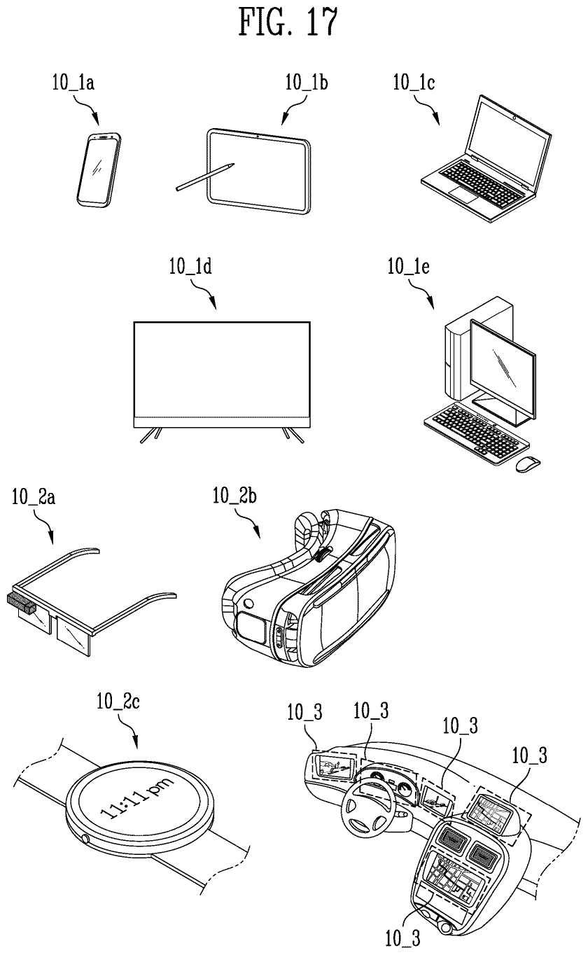

FIG. 17 shows schematic views of various embodiments of an electronic device.

Referring to FIG. 17, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various suitable changes in form and details may be made without departing from the spirit and scope of the present disclosure as set forth in the following claims, and equivalents thereof.

What is claimed is:

1. A method for manufacturing a pattern glass, the method comprising:
providing a plurality of guide films on a pattern glass having flat areas and a pattern area between the flat areas, wherein the plurality of guide films are in contact with side surfaces of the flat areas;
providing a first support film on top surfaces of the pattern glass and the plurality of guide films;
providing a second support film on bottom surfaces of the pattern glass and the plurality of guide films;
providing a shielding film having a through-hole formed therein on at least one selected from among the first and second support films, wherein the through-hole overlaps with the pattern area;
injecting an uncured resin into the pattern area of the pattern glass through an injection channel formed between the plurality of guide films; and
curing the uncured resin filled in the pattern area by irradiating a laser beam toward the pattern area exposed through the through-hole.

2. The method of claim 1, wherein the plurality of guide films comprise first to fourth guide films,
wherein one of the flat areas is between the first guide film and the second guide film, and
wherein another of the flat areas is between the third guide film and the fourth guide film.

3. The method of claim 2, wherein the injection channel is between the first and third guide films and between the second and fourth guide films.

4. The method of claim 1, further comprising providing a first adhesive film on the flat areas of the pattern glass and the top surfaces of the plurality of guide films between the providing of the plurality of guide films and the providing of the first support film.

5. The method of claim 4, wherein the providing of the first support film comprises attaching the first support film on a top surface of the first adhesive film.

6. The method of claim 4, further comprising providing a second adhesive film on the flat areas of the pattern glass and the bottom surfaces of the plurality of guide films between the providing of the plurality of guide films and the providing of the second support film.

7. The method of claim 6, wherein the providing of the second support film includes attaching the second support film on a bottom surface of the second adhesive film.

8. The method of claim 1, wherein the providing of the shielding film comprises the shielding film and the at least one selected from among the first and second support films such that the shielding film and the injection channel overlap with each other.

9. The method of claim 1, wherein the injection channel is defined by some of the plurality of guide films and the first and second support films.

10. The method of claim 1, wherein the injecting of the uncured resin comprises filling the uncured resin in a plurality of first groove patterns and a plurality of second groove patterns, which are formed in the pattern area, by a capillarity effect, and
wherein the plurality of first groove patterns have a shape recessed in a direction toward the bottom surface from the top surface of the pattern glass, and
the plurality of second groove patterns have a shape recessed in a direction toward the top surface from the bottom surface of the pattern glass.

11. The method of claim 10, wherein the plurality of first groove patterns and the plurality of second groove patterns extend in a direction parallel to a direction in which the injection channel extends.

12. The method of claim 10, wherein the plurality of first groove patterns and the plurality of second groove patterns are alternately provided along a direction intersecting a direction in which the injection channel extends.

13. The method of claim 10, wherein the irradiating of the laser beam comprises:
curing the uncured resin filled in the plurality of first groove patterns into a plurality of first resin patterns; and
curing the uncured resin filled in the plurality of second groove patterns into a plurality of second resin patterns.

14. The method of claim 13, wherein any one of the plurality of first groove patterns and any one of the plurality of first resin patterns, which are adjacent to each other, have shapes that are complementary to each other, and
wherein any one of the plurality of second groove patterns and any one of the plurality of second resin patterns, which are adjacent to each other, have shapes that are complementary to each other.

15. The method of claim 13, wherein top surfaces of the plurality of first resin patterns are on the same plane as the top surface of the pattern glass, and
bottom surfaces of the plurality of second resin patterns are on the same plane as the bottom surface of the pattern glass.

16. The method of claim 1, wherein the irradiating of the laser beam comprises controlling an output of a light source that emits the laser beam.

17. The method of claim 1, wherein the irradiating of the laser beam comprises shielding the laser beam irradiated onto the shielding film, and
wherein the uncured resin flowing in the injection channel is not cured.

18. The method of claim 1, wherein the first and second support films comprise the same material as the pattern glass or a hydrophobic material.

19. The method of claim 1, wherein the uncured resin comprises a material having the same refractive index as the pattern glass.

20. An electronic apparatus, comprising:
a pattern glass formed by:
providing a plurality of guide films on a pattern glass having flat areas and a pattern area between the flat areas, wherein the plurality of guide films are in contact with side surfaces of the flat areas;
providing a first support film on top surfaces of the pattern glass and the plurality of guide films;
providing a second support film on bottom surfaces of the pattern glass and the plurality of guide films;
providing a shielding film having a through-hole formed therein on at least one selected from among the first and second support films, wherein the through-hole overlaps with the pattern area;
injecting an uncured resin into the pattern area of the pattern glass through an injection channel formed between the plurality of guide films; and
curing the uncured resin filled in the pattern area by irradiating a laser beam toward the pattern area exposed through the through-hole.
